(19) United States
(12) Patent Application Publication
(10) Pub. No.: US 2026/0317881 A1
(43) Pub. Date: Oct. 15, 2026

(54) METHOD FOR SURFACE TREATMENT OF CORROSION-RESISTANT NICKEL-BASED ALLOY

(71) Applicant: Feedback Technology Corp., Hsinchu City (TW)

(72) Inventors: Tsung Feng Wu, Hsinchu City (TW); Chun-Chih Liao, Hsinchu City (TW); Po-Chia Huang, Hsinchu City (TW); Guo-Yang Ciou, Hsinchu City (TW); Chia-Te Lin, Hsinchu City (TW); Po-Han Chen, Hsinchu City (TW)

(21) Appl. No.: 19/633,476

(22) Filed: Mar. 30, 2026

Related U.S. Application Data
(62) Division of application No. 18/625,202, filed on Apr. 3, 2024.

(30) Foreign Application Priority Data
Aug. 7, 2023 (TW) 112129556

(51) Int. Cl. C23C 8/12; C22C 19/05; C22F 1/10; C23C 8/02; C23G 1/20

(52) U.S. Cl. CPC C23C 8/12; C22C 19/05; C22F 1/10; C23C 8/02; C23G 1/20

(57) ABSTRACT

A method for the surface treatment of a corrosion-resistant nickel-based alloy and the resulting surface structure of the treated alloy is disclosed. The method includes immersing a nickel-based alloy in a first neutral or alkaline solution to remove surface contaminants, followed by immersing the cleaned alloy in a second neutral or alkaline solution to form functional groups on its surface. Subsequently, a low-temperature heat treatment is performed to form a passivation layer on the surface of the nickel-based alloy. The passivation layer has a surface roughness of less than 0.04 microns and a thickness ranging from 5 nanometers to 200 nanometers. The resulting corrosion-resistant nickel-based alloy comprises a substrate made of the nickel-based alloy and a passivation layer established on at least one surface of the substrate. The nickel content of the alloy is greater than 50%, and the alloy also contain additional metallic components such as chromium and manganese.

### FIELD OF THE DISCLOSURE

The present invention relates to a method for the surface treatment of corrosion-resistant alloys, and more particularly, to a method for the surface treatment of corrosion-resistant nickel-based alloys and the resulting corrosion-resistant nickel-based alloys themselves.

### BACKGROUND OF THE INVENTION

Nickel-based alloys, known for their excellent mechanical properties and high corrosion resistance, are widely used across various industries. These alloys are particularly suited for harsh environments characterized by high temperatures, high pressures, and corrosive materials, such as those found in chemical processing, aerospace, and energy sectors. Despite the inherent corrosion resistance of nickel-based alloys, they are still prone to certain types of corrosion, especially under extreme conditions or prolonged use.

One of the primary challenges in using nickel-based alloys is the formation of a stable, protective passivation layer on the alloy surface. This layer, typically composed of metal oxides, acts as a barrier to prevent further corrosion of the underlying metal. However, forming a uniform, dense, and stable passivation layer on nickel-based alloys can be challenging. Traditional methods often involve high-temperature heat treatments, which can be energy-intensive and may adversely affect the microstructure and mechanical properties of the alloy. Moreover, the presence of surface contaminants, such as organic residues, hinders the effective formation of a passivation layer. These contaminants create irregularities in the layer, leading to increased susceptibility to corrosion in localized areas. Thus, there is a need for an effective method to remove these contaminants prior to the formation of the passivation layer.

Given these challenges, there is a significant demand for improved methods of treating nickel-based alloys to enhance their corrosion resistance. Specifically, the demand for a method capable of efficiently forming a stable and uniform passivation layer on the alloy surface, while being energy-efficient and preserving the inherent properties of the alloy, is a matter of consideration for those with ordinary skill in the art.

### SUMMARY OF THE INVENTION

In order to address the aforementioned challenges, the purpose of the present invention is to provide a method for surface treatment of a corrosion-resistant nickel-based alloy and the resulting corrosion-resistant nickel-based alloy.

Based on the above objectives and other purposes, this invention offers a method for the surface treatment of a corrosion-resistant nickel-based alloy, along with the resulting alloy. The method includes the following steps. Initially, the nickel-based alloy is immersed in a first neutral or alkaline solution to remove surface contaminants, with the pH value of this solution being between 7 and 12. Next, the cleaned nickel-based alloy is immersed in a second neutral or alkaline solution to form functional groups on the surface of the alloy, where the pH of the second solution also ranges between 7 to 12. Subsequently, the nickel-based alloy undergoes a low-temperature heat treatment process in an environment containing oxygen and a protective gas to form a passivation layer on at least one surface of the alloy, where the passivation layer possesses a surface roughness less than 0.04 microns and a thickness between 5 to 200 nanometers.

In one embodiment, the functional groups formed on the surface of the nickel-based alloy may be selected from a group consisting of hydroxyl, carbonyl, and carboxyl functional groups. Moreover, the first and second neutral or alkaline solutions can be chosen from various compounds, including sodium hydroxide, acetic acid, potassium hydroxide, and sodium chloride.

In another embodiment, the nickel-based alloy may be immersed in the first solution at a temperature between 25 to 50 degrees Celsius for a duration of 1 to 3 hours. During this immersion period, ultrasonic agitation may be performed. The alloy can be immersed in the second neutral or alkaline solution at a temperature between 25 to 60 degrees Celsius for a duration of 1 to 12 hours.

In another embodiment, the temperature of the low-temperature heat treatment process can range from 250 to 600 degrees Celsius, the gas flow rate can vary from 5 to 200 sccm, and the treatment time can span from 1 to 6 hours. The protective gas used may be selected from a group consisting of nitrogen and argon.

The corrosion-resistant nickel-based alloy obtained through the aforementioned method includes a substrate composed of a nickel-based alloy and a passivation layer established on at least one surface of the substrate. The nickel content in the nickel-based alloy can be greater than 50%, and the alloy may also contain Cr and Mn metals. The passivation layer can be a nickel-containing oxide layer (NiOx), a manganese oxide layer (MnOx), and a chromium oxide layer (CrOx) or a combination thereof.

In summary, the present invention provides an efficient method for surface treatment of a corrosion-resistant nickel-based alloy. Utilizing specific neutral or alkaline solutions and a low-temperature heat treatment process, a passivation layer is formed on the surface of the nickel-based alloy, enhancing its corrosion resistance. This method allows for the formation of specific functional groups on the alloy surface and the creation of a passivation layer with particular surface roughness and thickness. This makes the nickel-based alloy highly resistant to corrosion, suitable for various applications requiring such properties. The invention also provides the resulting corrosion-resistant nickel-based alloy, with a nickel content greater than 50%, potentially also containing Cr and Mn metals. That is, the passivation layer can be a nickel oxide layer (NiOx), manganese oxide layer (MnOx), or chromium oxide layer (CrOx), offering flexibility according to specific application needs.

The foregoing, as well as additional objects, features and advantages of the invention will be more readily apparent from the following detailed description, which proceeds with reference to the accompanying drawings.

### BRIEF DESCRIPTION OF THE DRAWINGS

The objects, spirits, and advantages of the preferred embodiments of the present disclosure will be readily understood by the accompanying drawings and detailed descriptions, wherein:

FIG. 1 illustrates a flowchart of the surface treatment method for the corrosion-resistant nickel-based alloy of the present invention.

FIGS. 2A to 2G illustrate schematic diagrams of the surface treatment method for the corrosion-resistant nickel-based alloy of the present invention at various steps.

### DESCRIPTION OF THE PREFERRED EMBODIMENTS

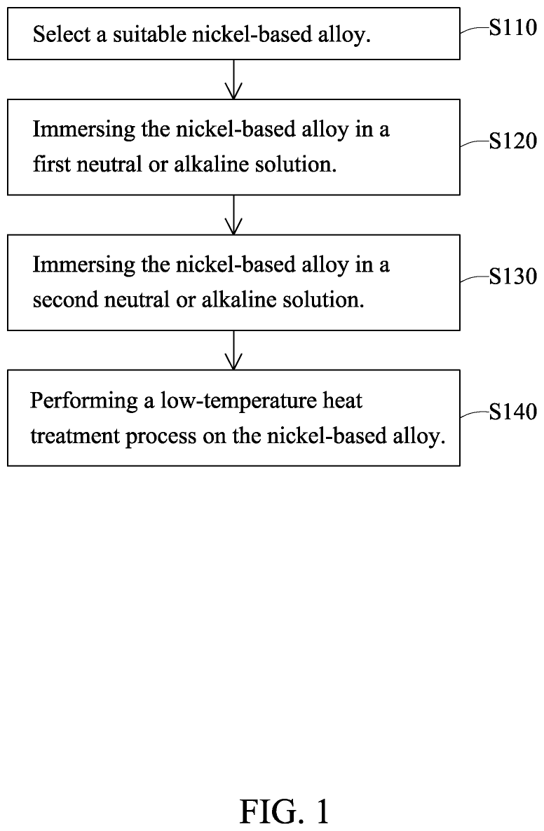

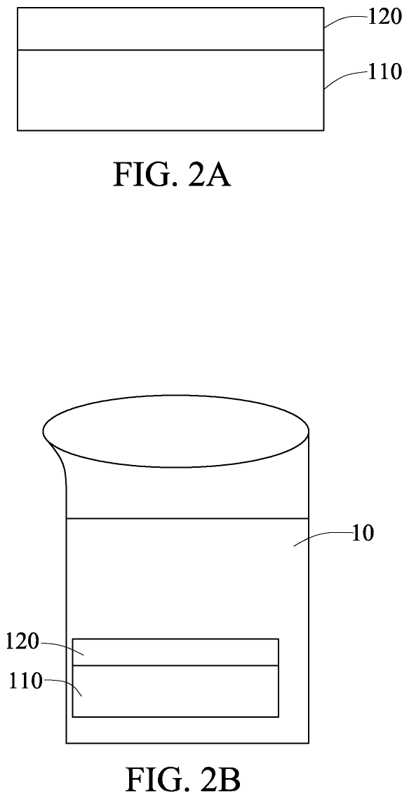

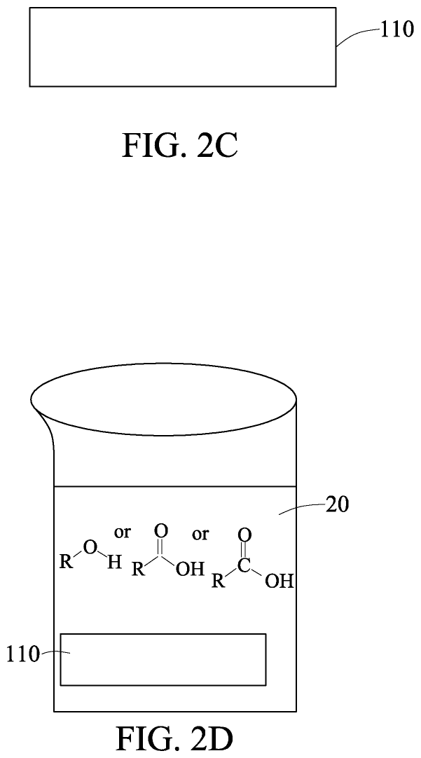

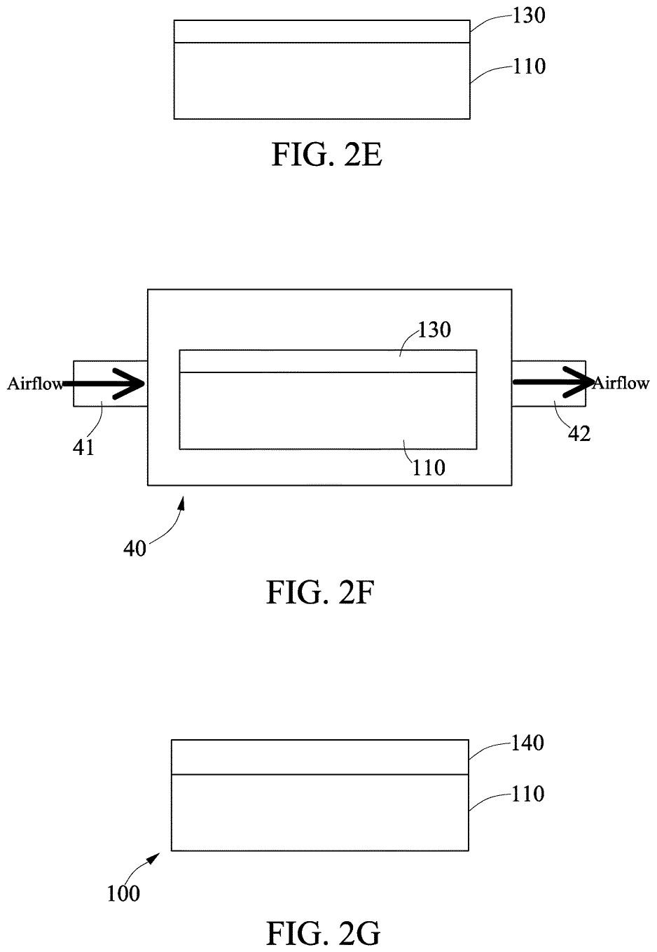

Referring to FIG. 1 and FIGS. 2A to 2G, FIG. 1 illustrates a flowchart of the surface treatment method for a corrosion-resistant nickel-based alloy according to the present invention, while FIGS. 2A to 2G show schematic diagrams of the surface treatment method at various steps.

Initially, as indicated in step S110 and referring to FIG. 2A, a suitable nickel-based alloy is selected. Nickel-based alloys are known for their excellent mechanical properties and high corrosion resistance, making them an ideal choice for various industries such as chemical processing, aerospace, and energy. In this embodiment, the chosen nickel-based alloy should contain more than 50% nickel to ensure a certain level of corrosion resistance. The nickel-based alloy may also include other metals like chromium (Cr) and manganese (Mn) to further enhance the alloy's corrosion resistance and mechanical properties. The specific composition of the nickel-based alloy in practical applications depends on the intended use and required properties. In this embodiment, the selected nickel-based alloy is prepared in the form of a substrate. Moreover, initial cleaning of the substrate, prior to proceeding to the next step, is crucial to remove any surface contaminants, such as organic residues, that might hinder the effective formation of a passivation layer. This initial cleaning prevents contaminants from creating irregularities within the layer, which could increase susceptibility to corrosion in localized areas.

In step S110, the cleaning process may involve standard techniques commonly used in the industry, such as ultrasonic cleaning in an appropriate solvent, followed by rinsing and drying. Care should also be taken to avoid introducing new contaminants during the cleaning process. This initial cleaning work lays the foundation for subsequent steps in the surface treatment method of the present invention. Once the nickel-based alloy has been preliminarily treated, it is ready for the next step S120, where the nickel-based alloy 110, as shown in FIG. 2A, is immersed in a first neutral or alkaline solution 10. It is important to note that, despite preliminary treatment, surface contaminants 120 that could not be removed during the initial treatment may still reside on the nickel-based alloy 110, necessitating the subsequent step S120. In FIG. 2A, surface contaminants are illustrated on only one surface of the nickel-based alloy 110, but it should be understood by those skilled in the art that surface contaminants can exist over the entire surface of the nickel-based alloy 110.

Referring to step S120 and FIG. 2B, after the initial treatment of the nickel-based alloy 110 is complete, step S120 involves immersing the nickel-based alloy 110 in the first neutral or alkaline solution 10. In this embodiment, the pH range of the first neutral or alkaline solution 10 is between 7 and 12. This range is more suitable for removing surface contaminants 120 from the nickel-based alloy 110 without causing adverse reactions that could potentially damage its surface. Specifically, a neutral to slightly alkaline solution helps to remove and dissolve most surface contaminants, including organic and inorganic residues, without causing excessive corrosion or dissolution of the nickel-based alloy 110.

In this embodiment, the specific solution used for this immersion process (i.e., the first neutral or alkaline solution 10) can include sodium hydroxide, acetic acid, potassium hydroxide, and sodium chloride with concentrations ranging between 1 millimolar and 1 molar. The choice of specific components and concentrations depends on the required functional groups and the needs for forming the passivation layer. These solutions are effective cleaners for metal surfaces.

Moreover, the immersion time and temperature also have a significant impact on the cleaning process. Immersing the nickel-based alloy in the solution at a temperature range of 25 to 50 degrees Celsius for 1 to 3 hours ensures an effective balance between the removal of contaminants and preventing unnecessary reactions or excessive dissolution of the metal. Additionally, ultrasonic agitation is employed during the immersion process. The use of ultrasonic energy enhances the cleaning process by creating microscopic bubbles that implode on the surface of the nickel-based alloy 110, a process known as cavitation. This operation helps to remove contaminants from the surface of the nickel-based alloy 110, achieving a more thorough cleaning process. Upon completion of step S120, the nickel-based alloy 110 can be more thoroughly cleaned, reducing the surface contaminants to a minimal level (as shown in FIG. 2C), and preparing it for the next step, S130.

Referring to step S130 and FIG. 2D, in step S130, the nickel-based alloy 110 is immersed in a second neutral or alkaline solution 20. The purpose of this step is to form functional group bonds on the surface of the nickel-based alloy 110, which act as catalysts during the formation of the passivation layer, accelerating its formation. The specific composition of the second neutral or alkaline solution 20 can be chosen from a combination of sodium hydroxide, acetic acid, ammonium hydroxide, potassium hydroxide, hydrogen peroxide, and sodium chloride, with concentrations ranging between 1 millimolar and 1 molar. The choice of specific components and concentrations depends on the required functional groups and the needs for forming the passivation layer. The pH range of the second neutral or alkaline solution 20 is between 7 and 12, ensuring the formation of the desired functional groups without causing adverse surface reactions or dissolution of the nickel-based alloy 110. In step S130, the functional groups formed can include hydroxyl, carbonyl, and carboxyl groups. These functional groups are chemically active, particularly hydroxyl groups, which can act as catalysts in the formation of metal oxide layers, thereby reducing the temperature required to form the passivation layer.

Furthermore, the duration and temperature of immersion in the second neutral or alkaline solution 20 are also critical. For example, a duration of 1 to 12 hours ensures sufficient time for the formation of functional groups on the surface of the nickel-based alloy 110. Additionally, choosing a temperature range of 25 to 60 degrees Celsius optimizes the formation of functional groups while preventing unwanted side reactions or excessive dissolution of the nickel-based alloy 110. Lower temperatures may slow the reaction rate, while higher temperatures could lead to undesirable side reactions or changes in the microstructure of the nickel-based alloy 110. Once step S130 is completed, the surface of the nickel-based alloy 110 will have a layer of functional groups 130 (as shown in FIG. 2E), laying the groundwork for the subsequent low-temperature heat treatment process.

Referring to step S140 and FIG. 2F, after the completion of step S130, the nickel-based alloy 110 undergoes a low-temperature heat treatment process. In step S140, the nickel-based alloy 110 is placed inside a heat treatment chamber 40 to undergo the low-temperature heat treatment. The internal conditions of the heat treatment chamber 40 play a significant role in the successful formation of the passivation layer 140 on the nickel-based alloy 110. By carefully controlling the temperature, airflow, pressure, and treatment duration within the heat treatment chamber 40, a dense, uniform, and stable passivation layer 140 can be formed, significantly enhancing the corrosion resistance of the nickel-based alloy 110. With the catalysis of the functional groups on the surface of the nickel-based alloy, the temperature inside the heat treatment chamber 40 can range from 250 to 600 degrees Celsius to form the passivation layer. This temperature range is much lower than the temperatures typically used in traditional methods for forming passivation layers, which often involve high-temperature heat treatments. The low-temperature heat treatment reduces energy consumption and results in a denser passivation layer.

Furthermore, the heat treatment chamber 40 is equipped with an inlet 41 and an outlet 42 for gas flow. Oxygen and a protective gas (such as nitrogen or argon) are introduced into the internal space of the heat treatment chamber 40 through inlet 41, while outlet 42 is used to remove excess gas and any byproducts of the heat treatment process. In this embodiment, the gas flow is controlled between 5 to 200 sccm, and the pressure ranges from 0.1 to 1 atmosphere. The protective gas can be nitrogen or argon, used to control the oxidation process and prevent unwanted reactions.

In step S140, the nickel-based alloy 110 is left in the heat treatment chamber 40 for 1 to 6 hours. The duration of the heat treatment allows for the complete formation of the passivation layer 140 while preventing excessive growth that could lead to a rough or uneven surface. Of course, the exact duration may depend on various factors, including the specific composition of the nickel-based alloy 110, the desired properties of the passivation layer 140, and the temperature of the heat treatment. Additionally, pressure control is also significant in the low-temperature heat treatment process. By controlling the pressure and the concentration of reactive gases inside the heat treatment chamber 40, uniform treatment is ensured and unnecessary reactions are prevented. Moreover, after the completion of the low-temperature heat treatment process, the heat treatment chamber 40 can be cooled down to room temperature in a controlled manner. Rapid cooling could induce thermal stress and damage the newly formed passivation layer 140, so in this embodiment, the cooling process is typically conducted slowly.

Following the low-temperature heat treatment process of step S140, the nickel-based alloy 110 forms a passivation layer 140 on at least one surface, resulting in the corrosion-resistant nickel-based alloy 100 as shown in FIG. 2G. In this embodiment, the passivation layer 140 has a surface roughness of less than 0.04 microns and a thickness between 5 to 200 nanometers, ensuring that the passivation layer 140 is smooth on the surface while being dense and uniform internally, effectively protecting the underlying nickel-based alloy 110 from corrosion.

Following the surface treatment method described in FIG. 1, a nickel-based alloy 110 with a protective passivation layer 140 is formed. A more detailed description of this corrosion-resistant nickel-based alloy 100 is provided below. The substrate of the corrosion-resistant nickel-based alloy 100 is made from the nickel-based alloy 110. The selection of the nickel-based alloy 110 depends on its inherent mechanical strength and corrosion resistance. In this embodiment, the nickel content in the nickel-based alloy 110 is greater than 50%, ensuring a certain level of corrosion resistance. This high nickel content allows the nickel-based alloy 110 to maintain its strength and corrosion resistance even under harsh conditions such as high temperatures or corrosive environments. In addition to nickel, the nickel-based alloy 110 may also contain other metals, such as chromium (Cr) and manganese (Mn), which can further enhance the alloy's corrosion resistance and other properties.

Furthermore, the passivation layer 140 is a protective barrier formed on at least one surface of the nickel-based alloy 110, effectively protecting the underlying nickel-based alloy 110 from environmental damage and significantly enhancing its corrosion resistance. The passivation layer 140 is a metal oxide layer formed through the low-temperature heat treatment process described in step S140 of FIG. 1.

In one instance, the nickel-based alloy 110 contains additional metals such as chromium (Cr) and manganese (Mn), allowing the passivation layer 140 to be composed of a mixture of different metal oxides. These mixtures may include nickel oxide, chromium oxide (CrOx), and manganese oxide (MnOx), each contributing in different ways to enhance the alloy's corrosion resistance.

Additionally, the passivation layer 140 has a surface roughness of less than 0.04 microns and a thickness ranging from 5 to 200 nanometers. These characteristics ensure the formation of a smooth, dense, and uniform passivation layer 140, effectively protecting the underlying nickel-based alloy 110. The appropriate thickness of the passivation layer 140 helps maintain the alloy's corrosion resistance, while the low surface roughness helps prevent the accumulation of contaminants, avoiding potential localized corrosion.

The above examples demonstrate a method for surface treatment of a corrosion-resistant nickel-based alloy and the resulting corrosion-resistant nickel-based alloy. The method includes immersing the nickel-based alloy in neutral or alkaline solutions and subsequent low-temperature heat treatment to form a stable and uniform passivation layer on the nickel-based alloy. This formation of the passivation layer significantly enhances the corrosion resistance of the nickel-based alloy, making it suitable for harsh conditions such as high temperatures, pressures, and corrosive environments. Moreover, the passivation layer, with controlled surface roughness and thickness, serves as a robust anti-corrosion barrier, effectively protecting the underlying nickel-based alloy. The passivation layer may consist of various metal oxides depending on the composition of the nickel-based alloy, each contributing to the overall corrosion resistance.

This surface treatment method for corrosion-resistant nickel-based alloys not only improves efficiency and energy consumption compared to existing methods but also retains the original properties of the nickel-based alloy. This makes the method an ideal solution for industries where the longevity and reliability of nickel-based alloys are of paramount importance.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A method for surface treatment of a corrosion-resistant nickel-based alloy, the method comprising:
immersing a nickel-based alloy in a first neutral or alkaline solution to remove surface contaminants, wherein the pH of the first neutral or alkaline solution is between 7 and 12;
immersing the cleaned nickel-based alloy in a second neutral or alkaline solution to form functional groups on the surface of the nickel-based alloy, wherein the ph of the second neutral or alkaline solution is between 7 and 12; and
performing a low-temperature heat treatment on the nickel-based alloy to form a passivation layer on at least one surface of the nickel-based alloy, wherein the low-temperature heat treatment is conducted in an environment containing oxygen and a protective gas, and wherein the passivation layer has a surface roughness of less than 0.04 microns and a thickness between 5 and 200 nanometers.

2. The method of claim 1, wherein the functional groups are selected from the group consisting of hydroxyl, carbonyl, and carboxylic acid functional groups.

3. The method of claim 1, wherein the first neutral or alkaline solution is selected from the group consisting of sodium hydroxide, acetic acid, potassium hydroxide, and sodium chloride.

4. The method of claim 1, wherein the second neutral or alkaline solution is selected from the group consisting of sodium hydroxide, acetic acid, ammonium hydroxide, potassium hydroxide, hydrogen peroxide, and sodium chloride.

5. The method of claim 1, wherein the immersion time of the nickel-based alloy in the first neutral or alkaline solution is between 1 to 3 hours, and the temperature is between 25 to 50 degrees Celsius.

6. The method of claim 1, wherein ultrasonic agitation is performed when the nickel-based alloy is immersed in the first neutral or alkaline solution.

7. The method of claim 1, wherein the immersion time of the nickel-based alloy in the second neutral or alkaline solution is between 1 to 12 hours, and the temperature is between 25 to 60 degrees Celsius.

8. The method of claim 1, wherein the temperature of the low-temperature heat treatment is between 250 to 600 degrees Celsius, the gas flow rate is between 5 to 200 sccm, the pressure is between 0.1 to 1 atmosphere, and the treatment time is between 1 to 6 hours.

9. The method of claim 8, wherein the protective gas is selected from the group consisting of nitrogen and argon.

10. The method of claim 1, wherein the protective gas is selected from the group consisting of nitrogen and argon.
